(19) United States
(12) Patent Application Publication
(10) Pub. No.: US 2026/0277591 A1
(43) Pub. Date: Sep. 17, 2026

(54) TECHNIQUES AND SYSTEM FOR UPDATING RESOURCES STORED IN FIRMWARE

(71) Applicant: Absolute Software Corporation, Vancouver (CA)

(72) Inventors: Eugene KHORUZHENKO, Vancouver (CA); Nicholas B. VAN SOMEREN, Vancouver (CA); Jeffrey Michael BUSH, Vancouver (CA); Stephen David DUNN, Vancouver (CA)

(21) Appl. No.: 19/670,281

(22) Filed: May 7, 2026

Related U.S. Application Data
(63) Continuation of application No. PCT/CA2024/051489, filed on Nov. 11, 2024.
(60) Provisional application No. 63/597,674, filed on Nov. 9, 2023.

(51) Int. Cl. G06F 8/65

(52) U.S. Cl. CPC G06F 8/65

(57) ABSTRACT

The disclosure relates to a device, comprising a processor; and memory connected to the processor. The memory comprising instructions that when executed by the processor cause the device to receive from a server, a secure message and storing the secure message in secure memory. The secure message contains binary for updating firmware. The device during a driver execution environment (DXE), checks the secure memory for the secure message and if present, copies the binary into an ACPI table. OS boot continues and the binary which has been copied to the ACPI table is executed. This has a similar effect as if the binary was updated directly in the firmware yet does not require the actual costly update of the firmware.

### TECHNICAL FIELD

The present disclosure relates to techniques for securely installing updated binaries at the firmware level. According to some embodiments, a secure messaging system can be secured to install updated binaries at the firmware level in a secure and non-editable manner.

### BACKGROUND

Currently, updating components of UEFI firmware can only be done by submitting the new components to the Original Equipment Manufacturer (OEM) and fully rebuilding the entire firmware image. This is very costly to the OEM as it requires a retest and a whole process of distribution of the new firmware update until it reaches the end user device. Ultimately, the end user is required to download the updated firmware from the OEM website and initiate a full Basic Input Output System (BIOS) update, it takes several minutes to complete with a few device reboots in the process. Many users will not complete the firmware update, leaving their devices vulnerable to attack or malfunction.

More, specifically, a standard firmware update mechanism uses a UEFI Firmware Management Protocol (FMP), using UpdateCapsule UEFI Runtime Function to pass the firmware update payload from the OS to the platform firmware. The EFI System Resource Table (ESRT) allows further targeting updates of specific resources within the firmware flash. The capsule contains the updating firmware component and must be signed by the OEM; it usually updates the entire BIOS firmware or distinct firmware volumes for Embedded Controller or Chipset firmware.

This method requires OEM involvement, is costly and time consuming, and it actually changes the firmware in the device. There remains a need for a simpler, secure way to update firmware components.

Methods of providing secure messaging to firmware components is known (see United States Patent Number 11,455,394), incorporated by reference herein. The system and method used to send secure messages is shown in FIGS. 1 and 2. This system can be further leveraged to securely install updated binaries at the firmware level.

### SUMMARY OF THE INVENTION

The disclosure relates to a device, comprising a processor; and memory connected to the processor. The memory comprising instructions that when executed by the processor cause the device to receive from a server, a secure message containing a binary, which can be updating an existing firmware resource or a new resource.

More specifically, the disclosure relates to a device, comprising a processor; and memory connected to the processor. The memory comprising instructions that when executed by the processor cause the device to receive from a server, a secure message and storing the secure message in a in common UEFI variable. The secure message contains binary of a specific firmware resource. The device during a driver execution environment (DXE), checks the mailbox UEFI variable for the secure message and if present, copies the binary into an ACPI table. OS boot continues and the binary which has been copied to the ACPI table is executed. This has a similar effect as if the binary was updated directly in the firmware yet does not require the actual costly update of the firmware.

One embodiment of the invention pertains to an electronic device comprising a processor and memory connected to the processor. The memory contains instructions that when executed by the processor cause the device to receive from a server, a secure message and storing the secure message in a common UEFI variable, the secure message being binary for updating firmware; the device during a driver execution environment (DXE), checking the mailbox UEFI variable for said secure message and if present, copies the binary into an ACPI table. Then, OS boot continues and the binary which has been copied to the ACPI table is executed.

In one embodiment of the invention, the binary can be placed into an ACPI table.

In a further embodiment of the invention, the binary represents a compressed form of an application that resides on the firmware of the device.

In another embodiment of the invention, the binary represents a compressed form of a service that resides on the firmware of the device.

In a further embodiment of the invention, the binary is saved in a locked and hidden manner.

In a further embodiment of the invention, the binary is saved in the DXE modifiable only variable.

In a further embodiment of the invention, after the binary is saved in the DXE modifiable only variable, the device reboots and after reboot the DXE driver passes DXE binary in the modifiable only variable to the OS.

In a further embodiment of the invention, the DXE driver creates a second UEFI variable with the binary.

In a further embodiment of the invention, the DXE driver checks the UEFI variables for the presence of the binary.

In a further embodiment of the invention, a registry is further updated with the binary.

Another embodiment of the invention pertains to an electronic device comprising: a processor and memory connected to the processor. The memory comprising instructions that when executed by the processor cause the device to receive from a server, a signed server key, while the device is booted, reboot a first time, verify the signed server key during a DXE (driver execution environment) phase of firmware in the device during a boot process of the device, send a nonce to the server while the device is booted, the nonce being encrypted using the signed server key; receive, while the device is booted, a secure message from the server that includes a first portion with the binary for updating firmware and a second portion that is based on a hash of the nonce, and reboot a second time. During the second boot, verify the secure message during the DXE phase of the firmware during another boot process of the device and copies the binary into an ACPI table.

In a further embodiment of the invention, the binary represents a compressed form of an application that resides on the firmware of the device.

In a further embodiment of the invention, the binary represents a compressed form of a service that resides on the firmware of the device.

In a further embodiment of the invention, the binary is saved in a locked and hidden manner.

In a further embodiment of the invention, the binary is saved in the DXE modifiable only variable.

In a further embodiment of the invention, after the binary is saved in the DXE modifiable only variable, the device reboots and on reboot the DXE driver passes DXE binary in the modifiable only variable to the OS.

In a further embodiment of the invention, the DXE driver creates a second UEFI variable with the binary.

In a further embodiment of the invention, the DXE driver checks the UEFI variables for the presence of the binary.

In a further embodiment of the invention, the registry is further updated with the binary.

Another embodiment pertains to a method for securely updating firmware of a device comprising the steps of:
a) receiving from a server, a signed server key, while the device is booted;
b) rebooting the device a first time;
c) verifying the signed server key during a DXE (driver execution environment) phase of firmware in the device during a boot process of the device;
d) sending a nonce to the server while the device is booted, the nonce being encrypted using the signed server key;
e) receiving, while the device is booted, a secure message from the server that includes a first portion with binary and a second portion that is based on a hash of the nonce;
f) rebooting the device a second time;
g) verifying the secure message during the DXE phase of the firmware during another boot process of the device; and
h) copies the binary into an ACPI table.

In a further embodiment of the invention, wherein the method includes saving the binary in a DXE modifiable only variable before the step of copying the binary into the ACPI table. It further includes the step of the DXE driver passes DXE binary in the modifiable only variable to the OS after verifying the secure message.

In a further embodiment, the method, after booting the DXE driver, checks the UEFI variables for the presence of the binary.

### BRIEF DESCRIPTION OF THE DRAWINGS

The features of the invention will become more apparent in the following detailed description in which reference is made to the appended drawings wherein:

FIG. 1 is a block diagram of a system for sending a secure message, according to prior art;

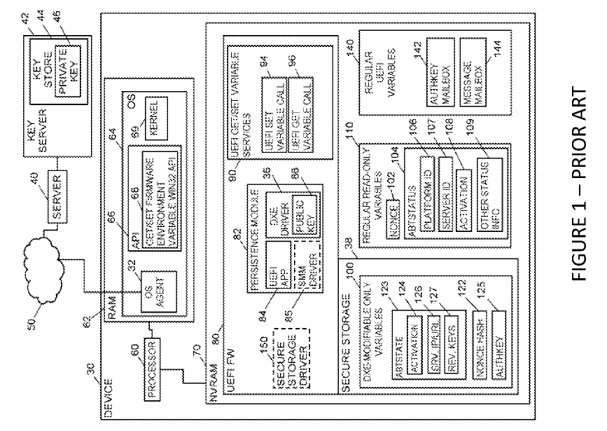

FIG. 2 is a sequence diagram showing the secure communication flow, according to prior art;

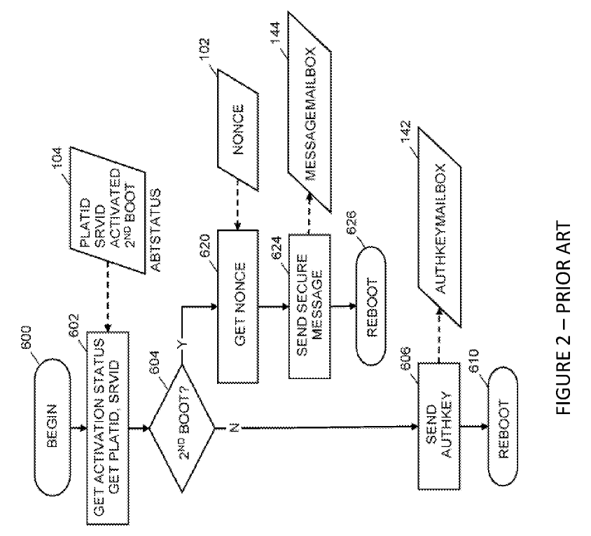

FIG. 3 is a block diagram of a system for sending a secure message containing new binary;

FIG. 4 is a sequence diagram showing the secure communication of new binary flow; and

FIG. 5 is a sequence diagram showing the how the new binary is launched upon boot.

### DETAILED DESCRIPTION OF PREFERRED EMBODIMENTS

According to some embodiments, a component can be updated remotely via the secure channel system using techniques described in, for example, United States Patent Number 11,455,394, incorporated herein by reference. In some embodiments, the server sends a specific secure message to a module capable of ensuring that an instance of an operating system agent (referred to herein as “office agent” herein) is present on a device (referred to herein as a “persistent module”). According to some embodiments, a persistence module can be used to store a new component in a hidden and/or locked UEFI variable. On a next boot, the persistence module can then process the secure message early in a DXE phase that allows creation of a special hidden and/or locked UEFI variable. From this point on, the persistence module can deploy the new component instead of the existing component version stored in the firmware file system.

The techniques disclosed herein can be used for resources stored in the firmware as opposed to the UEFI executable code. For instance, in one embodiment, the binary file sent via a secure message is a resource that is deployed via an Advanced Configuration and Power Interface (ACPI) table, and eventually starts as an operating system (e.g., Windows, Linux, MacOS, etc.) service. Embodiments of the present invention can deploy other OS components in a similar way to various client devices, including OEM or remote client devices that are configured to use a persistence module. These additional components can also be securely updatable using the techniques described herein.

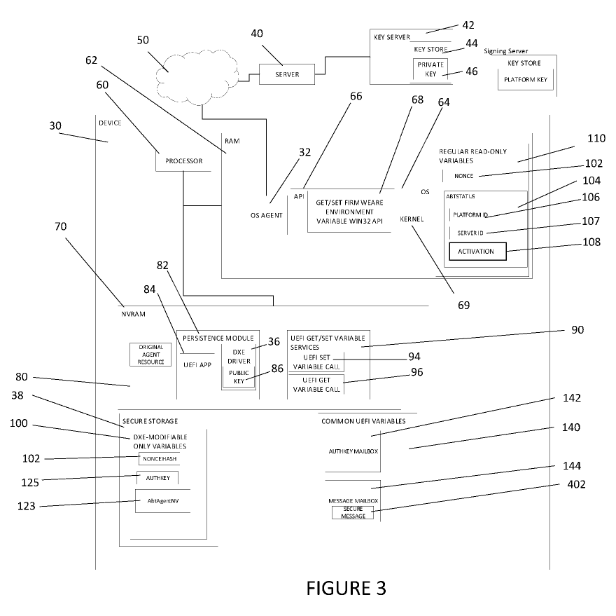

FIG. 3 is an embodiment of a system including a server 40, a key server 42 and a client computing device 30 that can be configured to perform the various techniques described herein.

FIG. 3 shows a block diagram of the modules of an exemplary system for sending secure messages containing data. The server 40 is shown connected to a separate key server 42, which includes a key store 44 and Server Authorization Key (SAK), having a private portion 46 of the server 40. The key server 42 generates and keeps the private portion of the SAK, the public portion of the SAK is later distributed as AuthKey 125. The key server 42 does not provide direct access to its key store 44, but only provides an API allowing clients to “use” the keys from key store (to encrypt/decrypt, sign/verify, etc.), but not to read/write the keys directly.

The server 40 is connected via the internet 50 to the device 30, which includes a processor 60 connected to RAM 62 and NVRAM 70. The RAM 62 stores the OS agent 32 and the OS 64. The OS 64 includes an API 66, of which a subset is the Get/Set Firmware Environment Variable WIN32 API 68. The kernel 69 of the OS 64 is also shown.

Resident in the NVRAM 70 are the secure storage 38 and the UEFI firmware (FW) 80.

The UEFI firmware 80 includes a persistence module 82, which ensures the presence of the OS agent 32 in the device 30. In some scenarios, if the OS agent 32 is deleted or corrupted, the persistence module 82 includes the functionality to download a fully functional OS agent from the server 40. The persistence module 82 includes the UEFI application 84, and the DXE driver 36. The DXE driver 36 is configured to store a copy of the platform public key 86. The platform public key 86 is built into the DXE driver 36 during manufacture. Another separate key server is a signing server, which generates and keeps the platform keys, and is used to sign the SAK, the public portion 125 of key 46. The signing server is not connected to anything for security reasons.

As described herein, embodiments of the present invention are configured to perform procedures within Driver Execution Environment as part of the earlier stages of the UEFI boot process. In some scenarios, during the DXE phase, drivers install boot services and runtime services. Later, during BDS phase, the UEFI configures devices, mounts drives, and finds and executes the boot code After control is transferred to the boot OS, runtime services stay resident to handle OS to UEFI calls and boot services are terminated.

Embodiments of the present invention are also configured to perform procedures using DXE-modifiable-only variables. In some scenarios, these variables include non-volatile Boot Services only variables locked with, for example, EDKII_VARIABLE_LOCK_PROTOCOL, EDKII_VARIABLE_POLICY_PROTOCOL, or a similar method at the end of the DXE phase. These variables are only modifiable during the DXE phase and are not visible at runtime. In contrast, standard non-volatile boot services UEFI Variables are writable before ExitBootServices() and can be modified from the UEFI Shell and OPROMs.

For instance, with further reference to FIG. 3, the UEFI firmware 80 includes the UEFI Runtime Get/Set Variable Services 90 which include the functionality to perform a UEFI Set Variable Call 94 and a UEFI Get Variable Call 96. In some embodiments, UEFI Runtime Get/Set Variable Services 90 are part of a UEFI core code designed to securely write data to the Secure Storage 38, Read Only Variables 110, and Common UEFI Variables 140. In this fashion, embodiments of the present invention perform functions via UEFI Get/Set Variable Services 90 during the DXE phase to prevent unauthorized applications and/or services from attempting to modify variables written to by embodiments of the present invention.

The DXE-modifiable-only variables 100 in secure storage 38 are accessed directly by the DXE driver 36 and locked at the end of the DXE execution phase by performing one or more API calls.

DXE-modifiable-only variables 100 are those that can only be modified during the DXE phase of a boot process because they are locked at the end of DXE phase. DXE-modifiable-only variables 100 include the NonceHash 102, the AuthKey 125, and any other variables maintained by the DXE driver 36.

Read-only variables 110 include a nonce 102 and a status variable (AbtStatus) 104. The status variable 104 is a single variable with separate fields, which include Platform ID 106, which is an ID of the particular OEM product line; the Server ID 107, which is the ID of the server 40; Activation field 108; and other status information.

The Common UEFI variables 140 include the AuthKey Mailbox 142 and the Message Mailbox 144.

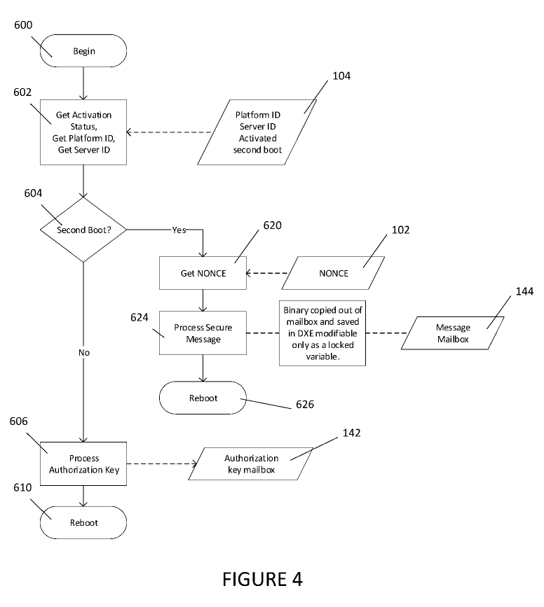

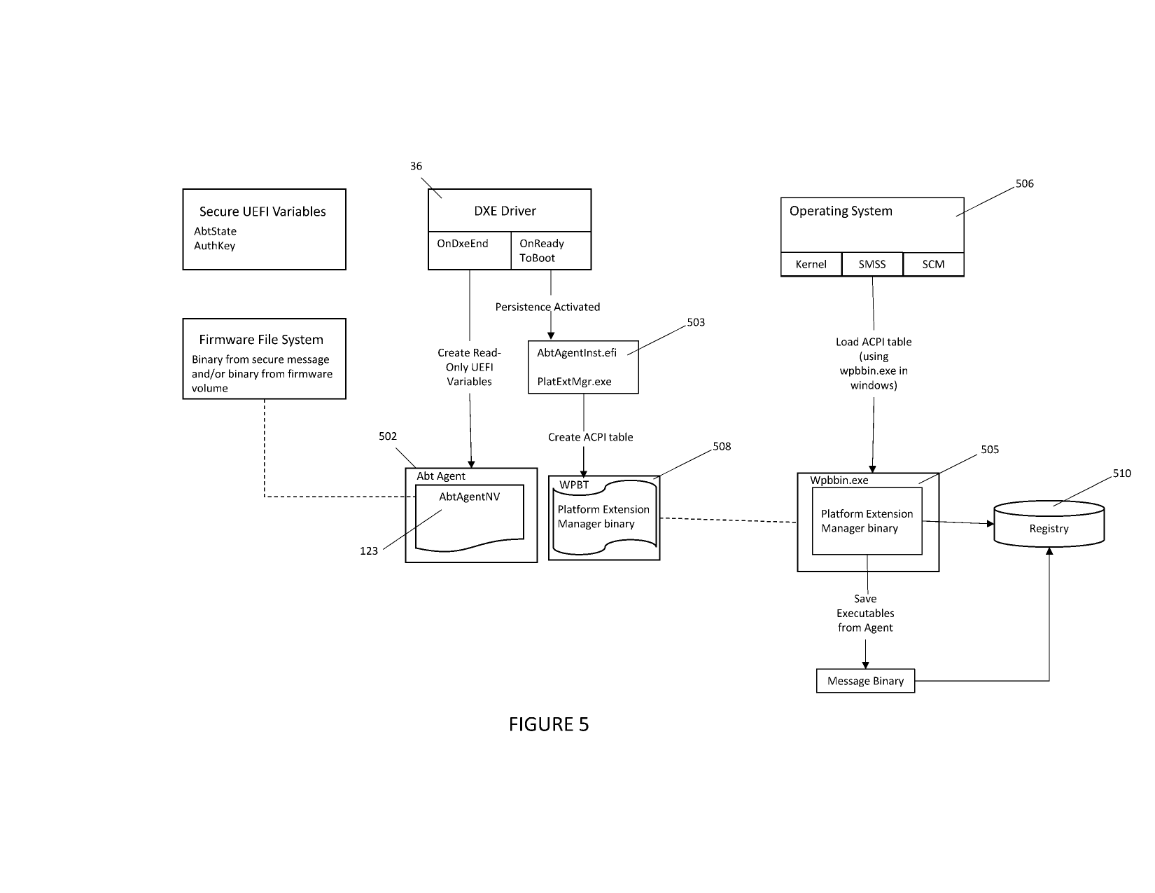

Accordingly, FIG. 3 provides a high-level overview of architectures that can be implemented by client computing device 30 in order to carry out the various techniques described herein. A more detailed breakdown of these techniques will now be provided below in conjunction with FIGS. 4 and 5. As described in greater detail below, these components can be utilized to update resources at the firmware level in a secure manner without involving the OEM.

FIG. 4 shows the process of sending the updated binary to a device via the secure messaging system according to some embodiments. The process begins with step 600, which is initiated by a utility that installs the full OS agent 32 and establishes communication with the authorized server 40. The installation utility installs the full OS agent 32, which immediately contacts the authorized server 40, which in turn controls the device 30 as described in US Patent No. 11,455,394, In accordance with the secure communication flow described with respect to FIG. 4 the messaging steps are as follows:

Referring to both FIG. 3 and 4, in step 602, the server 40 reads the Platform lD 106, Server lD 107, Activation 108 and other status information from the AbtStatus read-only variable 104 populated by the DXE driver 36.

For the purposes of the flowchart and ease of reference, the “first boot” is when the AuthKey is provisioned, and the “second boot” is when the AuthKey is successfully provisioned, and the secure message is sent. However, it can be appreciated by a person skilled in the art that it can be boot after the AuthKey has been provisioned. In the first communication phase, i.e. if in step 604 the AuthKey is not provisioned, the first task is to provision the server authorization key. In step 606, the server sends the signed authorization key blob to the device 30, which is written to the AuthKeyMailbox UEFI variable 142. A reboot occurs in step 610, and the DXE driver 36 verifies the authorization blob, extracts the authorization key, and saves it in the AuthKey DXE-modifiable-only UEFI variable 125.

After the reboot, the OS agent 32 takes control and communicates with the server 40 again, the process restarting from step 600. In step 602, the server checks that the 2nd Boot status is set, which means that the AuthKey was accepted by the BIOS and the device 30 now expects the secure message. Since AuthKey has been provisioned, the test in step 604 is affirmative and leads to step 620, in which the server 40 reads a nonce read-only variable 102 created by the DXE driver 36 on the second boot. The above describes how the secure messaging system embodiments of the present invention can send different types of secure messages from the server to send different commands and data to the persistence module. These commands and data implement different functions within the device. The following describes how a specific type of command is introduced specifically to update the OS persistence agent within the device. It can be appreciated that the same method could be used to “update” other elements in the firmware.

In step 624, the server uses the nonce to construct a secure message 402 containing a new binary (see FIG. 3). In one embodiment, the binary represents a compressed form of an application or service that resides on the firmware of a device and is capable of being updated. The server then sends the secure message 402 to the device 30. The OS agent 32 saves the secure message 402 to the MessageMailbox UEFI variable 144. The device is then rebooted in step 626.

After the second reboot, the DXE driver 36 validates the secure message 402 and saves the content of the secure message e.g., a binary generated from a remote computing device) in the DXE-modifiable-only variable 123 (e.g., identified as AbtAgentNV for illustrative purposes). In this manner, the binary image is saved in a locked/hidden manner and cannot be tampered with by an unauthorized application or service. For instance, the secure storage 38 is locked down at the end of the DXE phase (e.g., end of EndOfDxe event) to prevent tampering. Since the binary came through the secure messaging system, the authorization, authenticity, and integrity of the message is confirmed.

After the binary is saved in the DXE modifiable only UEFI variable 123 (in this example, the UEFI variable is called AbtAgentNV), the steps taken on the next boot are shown in FIG. 5. The DXE driver 36 runs and prepares to pass the previously downloaded binary in the AbtAgentNV 123 from the firmware to the OS of the client device. In one scenario, the DXE driver creates second UEFI variable with the binary previously received in the secure message. The DXE driver 36 checks the UEFI variables in the DXE - modifiable variables storage for the presence of new binary. The DXE driver 36 checks if AbtAgentNv 123 exists on every boot. If it does not exist (for example, when no update was requested) then the DXE driver 36 reads the original agent resource 101 and copies it in AbtAgent variable 502. If the AbtAgentNv 123 exists because it was previously created when the server sent a secure message with the updated agent binary, then the driver copies AbtAgentNV 123 into AbtAgent, 502 effectively replacing the old agent with the new one.

The DXE Driver 36 schedules a secondary UEFI application (in this example, called AbtAgentInst.efi 503) to run at the end of boot, the purpose of which is to create an ACPI table 508. In the case of a Windows® based system, this would be the Windows® Platform Binary Table (WPBT), although other ACPI tables would be known to a person skilled in the art. In the ACPI table 508, DXE Driver adds a binary, called Platform Extension Manager.

As the OS boot starts, the OS 506 locates and loads the ACPI table 508 and copies the binary from the ACPI table 508 (which includes the platform extension manager) to a new file. In the case of a Windows® System, the binary in the ACPI table 508 is copied to wpbbin.exe 505. Wpbbin.exe 505 is executed very early in the Windows® boot. As the OS 506 runs wpbbin.exe, the platform extension manager locates the AbtAgent read only variable 502, it copies the binary in the AbtAgent 502 to the OS file system. The platform extension manager binary also updates the registry 510 to “install” the message binary so that later in the boot, the message binary is executed on the device.

While in the example above, binary was passed from the firmware to the OS, embodiments of the present invention are not limited to such examples.

It should be appreciated that the updates performed by embodiments of the present invention do not change the actual firmware image bytes. The new binary is deployed dynamically on every boot, if it was provisioned via the AbtAgentNV 123. In one embodiment, if the variable was not provisioned or was deleted, the original component image located in the firmware is used.

By using the secure message system to send the binary to each device in a network, the binary can be saved during the DXE phase of the boot. By saving the binary during DXE phase, the binary can be saved in a secure, locked and optionally hidden way.

This system and method are particularly advantageous in networks with many devices as it avoids the need for the expensive and time-consuming involvement of the OEM.

1. An electronic device, comprising:
a processor; and
memory connected to the processor;
the memory comprising instructions that when executed by the processor cause the device to:
receive from a server, a secure message and storing the secure message in secure memory, the secure message being binary for updating firmware;
the device during a driver execution environment (DXE), checking the secure memory for said secure message and if present, copies the binary into an ACPI table;
OS boot continues and the binary which has been copied to the ACPI table is executed effectively updating the firmware.

2. The device of claim 1 wherein the binary represents a compressed form of an application that resides on the firmware of the device.

3. The device of claim 1 or claim 2 wherein the binary represents a compressed form of a service that resides on the firmware of the device.

4. The device of any one of claims claim 1 to 3 wherein the binary is saved in a locked and hidden manner.

5. The device of any one of claims claim 1 to 4 wherein the binary is saved in the DXE modifiable only variable.

6. The device of any one of claims claim 1 to 5 wherein after the binary is saved in the DXE modifiable only variable, the device reboots; and
on reboot the DXE driver passes DXE binary in the modifiable only variable to the OS.

7. The device of claim 6, wherein the DXE driver creates a second UEFI variable with the binary.

8. The device of claim 7 wherein the DXE driver checks the UEFI variables for the presence of the binary.

9. The device of any one of claims claim 1 to 8 wherein a registry is further updated with the binary.

10. An electronic device, comprising:
a processor; and
memory connected to the processor;
the memory comprising instructions that when executed by the processor cause the device to:
receive from a server, a signed server key, while the device is booted;
reboot a first time;
verify the signed server key during a DXE (driver execution environment) phase of firmware in the device during a boot process of the device;
send a nonce to the server while the device is booted, the nonce being encrypted using the signed server key;
receive, while the device is booted, a secure message from the server that includes a first portion with the binary for updating firmware and a second portion that is based on a hash of the nonce;
reboot a second time;
verify the secure message during the DXE phase of the firmware during another boot process of the device; and
copies the binary into an ACPI table.

11. The device of claim 10 wherein the binary represents a compressed form of an application that resides on the firmware of the device.

12. The device of claim 10 or claim 11 wherein the binary represents a compressed form of a service that resides on the firmware of the device.

13. The device of any one of claims claim 10 to 12 wherein the binary is saved in a locked and hidden manner.

14. The device of any one of claims claim 10 to 13 wherein the binary is saved in the DXE modifiable only variable.

15. The device of any one of claims claim 10 to 14 wherein after the binary is saved in the DXE modifiable only variable, the device reboots; and
on reboot the DXE driver passes DXE binary in the modifiable only variable to the OS.

16. The device of claim 15, wherein the DXE driver creates a second UEFI variable with the binary.

17. The device of claim 16 wherein the DXE driver checks the UEFI variables for the presence of the binary.

18. The device of any one of claims claim 10 to 17 wherein the registry is further updated with the binary.

19. A method for securely updating firmware of a device comprising the steps of:
receiving from a server, a signed server key, while the device is booted;
rebooting the device a first time;
verifying the signed server key during a DXE (driver execution environment) phase of firmware in the device during a boot process of the device;
sending a nonce to the server while the device is booted, the nonce being encrypted using the signed server key;
receiving, while the device is booted, a secure message from the server that includes a first portion with binary and a second portion that is based on a hash of the nonce;
rebooting the device a second time;
verifying the secure message during the DXE phase of the firmware during another boot process of the device; and
copies the binary into an ACPI table.

20. The method of claim 19 wherein before the step of copying the binary into the ACPI table, saving the binary in a DXE modifiable only variable; and after verifying the secure message, the DXE driver passes DXE binary in the modifiable only variable to the OS.

21. The method of claim 20 wherein after booting the DXE driver checks the UEFI variables for the presence of the binary.
